(19) United States
(12) Patent Application Publication
(10) Pub. No.: US 2010/0312860 A1
(43) Pub. Date: Dec. 9, 2010

(54) Planning And Controlling Of Objects Transportation

(75) Inventor: Horst Lohstoeter, Hamburg (DE)

Correspondence Address: LERNER, DAVID, LITTENBERG,;KRUMHOLZ & MENTLIK, 600 SOUTH AVENUE WEST, WESTFIELD, NJ, 07090, US

(73) Assignee: AIRBUS OPERATIONS GMBH, Hamburg (DE)

(21) Appl. No.: 12/739,050

(22) PCT Filed: Nov. 29, 2007
(86) PCT No.: PCT/EP07/63023

§ 371 Date: May 20, 2010

(51) Int. Cl. G06F 15/16

(52) U.S. Cl. 709/219

(57) ABSTRACT

The invention relates to a system, a method and a computer program for planning and controlling of objects transportation. A request for transport of an object is sent from a client unit to a server unit, which receives and processes the request and asks a transport planner to accept the request. A request list considering information about object details and the time of delivery is created. Hereinafter transport instructions are automatically sent to data transferring devices and the transport instructions are being executed.

### TECHNICAL FIELD

This invention relates to a system, a method and a computer programme for planning and controlling of objects transportation.

### PRIOR ART

When manufacturing large, voluminous, complex and expensive machines, it is advisable to optimise the transport of all parts, modules, components and subsystems of the manufactured machines, in order to save money, time and factory space. Especially in the manufacturing of large passenger aircraft, it is highly appreciated to build large subparts and buy systems delivered by third parties just in time.

Usually the transport and delivery of parts for manufacturing is planned manually by studying the manufacturing process and the timetables and requesting parts in time.

The requests are usually accomplished manually, by filling in forms and handing them to a transport planner. The transport planner hands out transport orders to transport personnel, who needs to collect these requests in a predetermined office on the factory area. These orders can be handwritten and contain compressed information about the parts to be delivered. Thus, it can be hard to read these orders, they may contain errors or are imprecise.

Furthermore, the transport of parts on very large factory areas is time consuming and needs organising of transport vehicles and transport times that can be underestimated, when stacking, storage positions and vehicle usage are changing.

It is therefore an object of the invention to provide a system, a method and a computer programme for planning and controlling the transport of parts that enables an optimum usage of available resources, improves the communication between requesting customers and transport personnel and can be accomplished in time and cost efficient.

### SUMMARY OF THE INVENTION

This object is achieved by providing a system for planning and controlling of objects transportation, wherein the system comprises:
at least one server unit;
at least one client unit;
at least one communication device;
at least one database unit with objects and factory area data, adapted to interact with the at least one server unit;
wherein the at least one client unit is adapted to send requests for objects to the at least one server unit;
wherein the at least one server unit is adapted to receive and process the requests for objects; and
wherein the at least one server unit creates a request list considering at least informations about the object and the time of delivery of the object and automatically sends transport instructions to data transferring devices using the at least one communication device.

In this context, objects are also referred to as parts and define all components, modules, subassemblies and members of the product to be manufactured.

The server unit comprises means for inputting requests for parts that need to be delivered to the manufacturing areas (e.g. an assembly line). The requests contain information about the part itself, the recent part storing position, the location the part must be delivered to, the date and the time when it must be delivered and the requesting customer, in order to integrate it into the future product just in time. A customer, e.g. a person in charge for the assembly of an aircraft, can file a request manually by filling in specific input forms on a computer, for example.

At least one database unit contains information about all available parts and the factory area. The server unit creates a request list which is a collection of requests as a timetable, in which all parts to be delivered are included. A transport planner is able to allocate transport workers and transport vehicles at desired times to all listed request using the system according to the present invention, which leads to an automatic transmission of necessary transport orders to be executed to the transport workers. Alternatively, the server unit may automatically generate these transport tasks out of the multitude of requests under consideration of delivery time, part information, recent storage positions and place to be delivered to. With a given transport duration for each part, availabilities of transport vehicles and transport workers a latest possible transport task start time can be determined by way of standard optimisation algorithms. In general, each part request leads to a transport task or several sub tasks, that will be allocated with the available transport personnel and transport vehicles in a way that the tasks can be accomplished in time with a minimum effort.

In order to inform the transport personnel about incoming transport tasks, it is adapted to send messages to the personnel using a communication unit and an electronic data transferring device. Thus, it is not necessary to hand out written requests to the transport personnel and they do not need to collect these requests in a predetermined office on the factory area. Furthermore, due to the direct transmission of transport requests using a centralised system, information loss can be eliminated.

For this purpose, the data transferring devices are preferably wireless data transferring devices. These can be personal digital assistants (PDAs), mobile phones or similar devices.

It is further preferred, that communication device and the wireless data transferring devices communicate using DECT. This standard is broadly used and the wireless data transferring devices may also be used as a simple phone in a company environment, if favoured.

Moreover, it is preferred, when the communication device and the wireless data transferring devices communicate using wireless ethernet, since this technology also is broadly used and an existing wireless ethernet in a company could be used for this purpose without building up a new infrastructure.

In a preferred embodiment the wireless data transferring devices are adapted to send transport begin and/or transport progress and/or transport interruption and/or transport completion messages to the at least one server unit. Therefore it is possible for the transport personnel to inform the server unit about the transport progress without effort.

The server unit being adapted to report the start and/or progress and/or interruption and/or completion of the transport to a transport planner or a customer is also preferred. So, the server unit can report difficulties or transport failures easily to the customer or the transport planner.

In a further preferred embodiment the server unit is adapted to automatically check the plausibility of a transport plan, enabling the server unit to detect probable failures in the execution of the transport plan. The entirety of the transport tasks are defined as the transport plan.

In a still further preferred embodiment, the server unit is adapted to automatically rebuild the transport plan in case of the plausibility is negative or the completion of a transport task is not possible in time, thus enabling the whole system to dynamically react on failures and unforeseen events during the transport task.

The objects of the invention are also achieved by a method for planning and controlling of objects transportation, said method comprising following steps:
sending a request for transport of an object from the at least one client unit to the at least one server unit,
receiving and processing the request by the at least one server unit,
accepting the request by a transport planner,
creating a request list considering at least informations about the object and the time of delivery of the object, and
automatically sending transport instructions to data transferring devices using a communication device.

Preferably, transport tasks are executed from the request list, which are executed and the start and/or progress and/or interruption and/or completion of the transport task is reported to the server unit using data transferring devices.

It is further preferred, that the server unit reports the start and/or progress and/or interruption and/or completion of the transport task to the transport planner and/or the customer.

Still further preferred the server unit automatically checks the plausibility of a transport plan, which is the entirety of the transport tasks.

The objects are further achieved by a computer programme for planning and controlling of objects transportation for carrying out the steps according to the method described above, when the computer programme is run on a computer, wherein this computer programme comprises:
first programme code means for sending a request for transport of an object from the at least one client unit to the at least one server unit;
second programme code means for receiving and processing the request by the at least server unit;
third programme code means for accepting the request by a transport planner;
fourth programme code means for creating a request list considering at least informations about the object and the time of delivery of the object; and
fifth programme code means for automatically sending transport instructions to data transferring devices using a communication device.

Preferentially the computer programme is adapted to perform one or several of the above mentioned preferred steps and embodiments of the method for planning and controlling of objects transportation according to the invention.

### BRIEF DESCRIPTION OF THE DRAWINGS

The present invention is illustrated by way of example and not limitation in the accompanying figures, in which similar references indicate similar elements, and in which:

FIG. 1 illustrates the general functional architecture of the system according to the present invention in a schematic drawing,

FIG. 2 shows the general technical architecture of the system according to the present invention in a schematic drawing, and

FIG. 3 displays the method for transport planning and controlling according to the present invention.

### PREFERRED EMBODIMENTS OF THE INVENTION

In accordance with the present invention, the embodiment shown provides means for efficiently planning and controlling goods transport for an optimised material flow of manufacturing factories. The invention is described based on the aircraft manufacturing industry as an example.

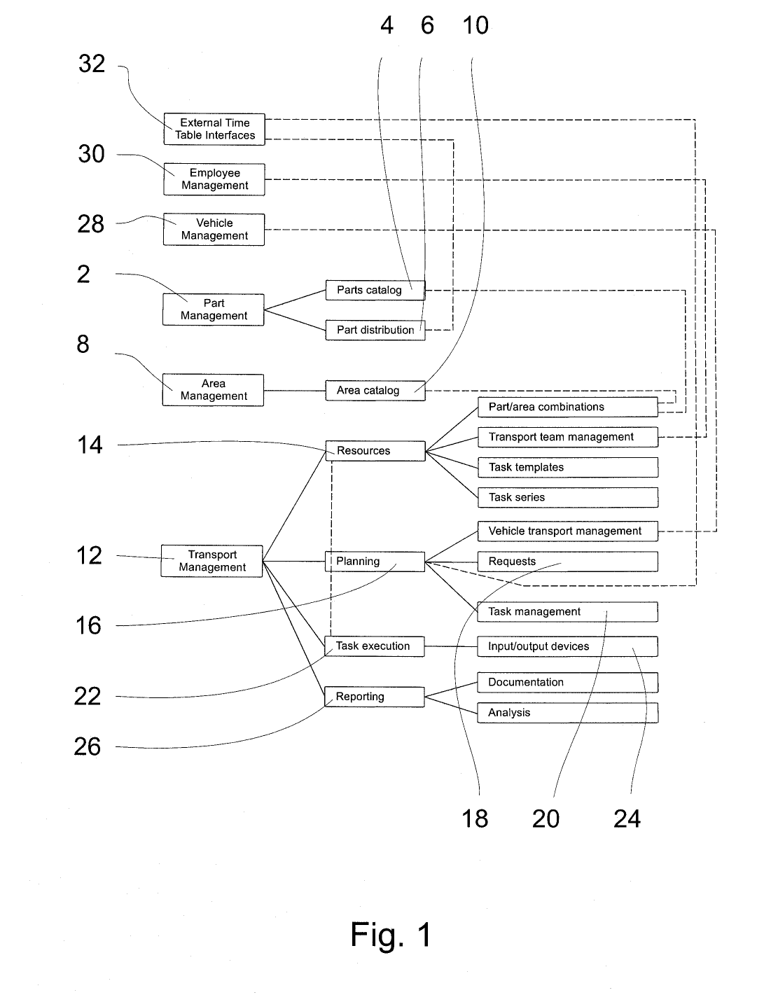

FIG. 1 is addressed to the general functional architecture of the system. There, a parts management module 2 is responsible for handling all parts data. The parts management module 2 is an application that manages and collects the parts needed for manufacturing of a product. In the example of an aircraft manufacturing industry these parts may be wing or fuselage panels, structural support parts, hydraulic components, engines, electronic components and many more. Since this module is preferably independent from other modules of this system, all master data from this module can be reused by totally different systems or the system of the present invention might use already existing master data about the parts. The parts management module 2 therefore may include a full parts catalog 4 with necessary data about parts used during the manufacturing. The parts management module 2 further deals with the parts allocation 6, through which all needed parts are allocated to a unique future product. This might include not just allocating model numbers or part numbers in general but concrete parts including a unique serial number. This leads to the ability to document the whole set of aircraft used during the manufacturing.

An area management module 8 manages, controls and collects all relevant information about all zones of the factory area. These zones can be production areas, loading positions, train stations, parking spots, offices etc. The zones are sorted hierarchically. This means, that an office is a sub zone of a building, for example. The master zone is the complete factory area. The area management module 8 includes an area catalogue 10 with zone locations and e.g. maximum surface load values and sizes of storing positions. Optionally, the provided informations can contain GPS data for precise navigation on larger factory areas. Furthermore an aerial photograph of the whole factory area (master zone) is provided, where all storing positions or already positioned parts can be depicted by processing with a dedicated application.

A transport management module 12 is an application for planning, coordinating, executing and documenting of the transport tasks. The transport management modules contains the sub modules resources 14, planning 16, task execution 22 and reporting 26 thus enabling a full management for transporting parts by transport workers from all relevant zones to the manufacturing area.

Within the sub module resources 14 a dynamic allocation of storing positions to parts can be provided. This part/area combination can be a part positioned onto a certain storage position, that is defined in the area catalogue 10 provided by the area management module 8. Also in this sub module, a transport team management application deals with coordination transport workers that are responsible for the transport of the parts. Task templates and task series ease up the planning and description of transport tasks by reducing the mandatory inputs for task planners.

In the sub module task planning 16 requests from customers are received and forwarded by a request processing application 18 to a task planner having the ability to accept or decline requests. In case a request has been accepted it will be transformed into a single transport task or multiple sub tasks that each need to be linked with resources and filled with detailed task descriptions in cooperation with a task management application 20.

In order to fulfill planned tasks, that are completely assigned with resources and transport workers the transport task appears in a task list or similar and waits for execution by the sub module execution 22. A message with detailed task information can be sent via input/output devices 24. The message can be an email or a short message wirelessly transmitted to a handheld device or similar. Thus, the sub module for task execution 22 can trigger the physical execution of a planned task. If necessary, a task can be interrupted, deleted or shifted by an operator. After a task has been finished or interrupted, a feedback to the task planning module 16 enables the seamless succession of the next tasks.

Besides planning and executing tasks the transport management module 12 is able to report the planning and execution progress of tasks to task planners and customers. This is concluded by a reporting application 26, that is able to print and display documentation and analysis about task planning and execution progress for information purposes.

Some further modules can be integrated into the system according to the present invention. These may be a vehicle management module 28 that deals with availability, integrity, capacities and capabilities of vehicles and their locations, if not already defines by the transport management module 12. Also, an employee management module 30 can be integrated that is able to provide information about employee availabilities, absences and locations as well as general shift plans, if not provided by the transport management module 12. Various other modules are possible for effectively intermesh the system according to the present invention with already existing company networks, databases, interfaces or other systems and tools for production planning

In order to optimise the system, interaction between the above mentioned modules is necessary. Interactions between modules are depicted by dashed lines in FIG. 1. As can be seen, the resources management 14 e.g. interacts with the area catalogue 10, with the parts catalogue 4 and with the employee management module 30. This enables the resources management 14 to allocate parts to areas and to find out the availability of needed transport workers. Further, the task planning application 16 may interact with the vehicle management module 28 to find out the availability of transport vehicles and to allocate a certain vehicle to a certain transport task. It is clear that the interacting of the resources management application 14, the planning application 16 and the task execution 22 within the module transport management 14 is mandatory. Furthermore, all above described modules can interact with a global manufacturing time table 32 which indicates the planned completion of the products, for example. Lastly, the interaction between modules can be further optimised in providing a plausibility check wherever possible. As an example, if a transport vehicle should be allocated to two different tasks at the same time due to an error, a plausibility check will discover a need for changing the allocation.

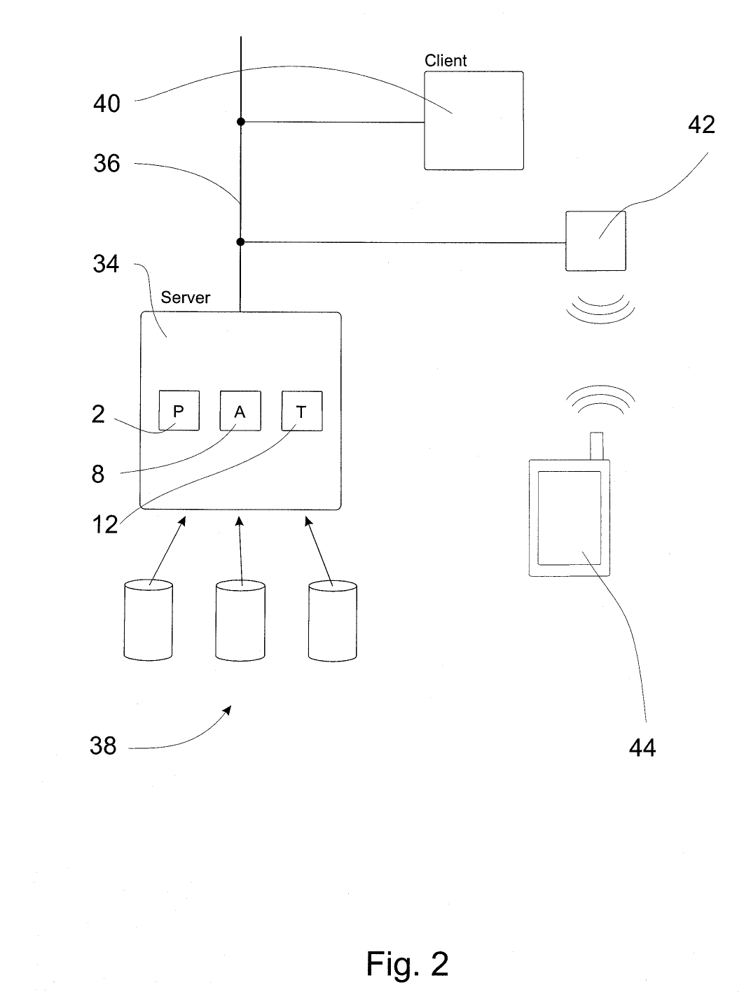

FIG. 2 is addressed to the general technical architecture of the system according to the present invention. The core piece of the system is a server 34 that processes requests and handles communication between requesting customers, task planners and transport workers. The server 34 can also be realised as a group of servers communicating with each other and share their processing workload. The server 34 preferably has an operating system installed that enables the server 34 to run a programme or a framework system that allows several interacting and customisable programme modules to be executed in parallel.

The server 34 is connected to a network 36 which can be realised by a protocol such as TCP/IP which is commonly used in company internal networks for a broad variety of applications. Network 36 can also be a main internal network of the company, therefore there is no extra cost for building up a completely new network.

Integrated into the server 34 by computer programmes are the part management module 2, the area management module 8 and the transport management module 12. Communicating with the or integrated into the server 34 is a database 38 or a group of databases 38 that store and output information about the zones in the factory area, the parts for the manufacturing of the product, shift plans, timetables etc. for manufacturing the product.

Further connected to network 36 are several end-user workstations 40, further also referred to as clients or client units 40. Besides that, devices for wireless data transfer or wireless communication 42, such as WLAN access devices or DECT data transfer devices, are attached to the network 36. With these, it is possible for transport planners or workers to communicate via handheld devices 44, such as PDAs, DECT telephones or other with the server 34 in order to send and receive transport instructions or send or receive transport task failure, progress or completion reports.

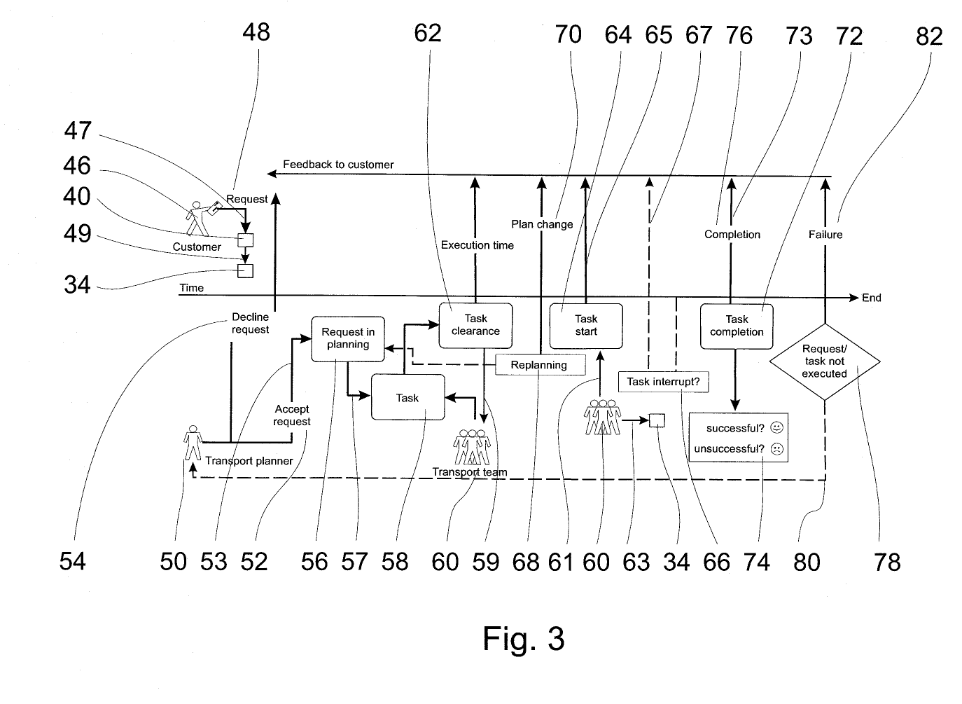

FIG. 3 describes the whole process from requesting a part by a customer until completion of the work task in detail. In FIG. 3 the horizontal axis is time, thus the further method or process steps are oriented towards the right side, the later they take place. The upper half of FIG. 3 is dedicated to customers whereas the lower half is dedicated to the transport team.

A customer 46, which can be a person in charge of an assembly, files a request 48; that is input into a workstation or another client 40 connected over network 36 to server 34. This input can be achieved by filling in forms, clicking menus or other typical means of electronic input. In the transport team, a transport planner 50 will be informed about the new request 46 via email or other communication means. The planner 50 is then asked by sub module planning 16 of the transport management module 12 to accept 52 or decline 54 the request 48. In case that the request 48 is declined 54, the customer 46 will be informed electronically.

An accepted request leads to a request status “in planning” 56. The sub module planning 16 processes the available data and creates a transport task 58, that is linked with resources like the transport workers 60 as well as detailed task description, cooperating with the task management application 20. A possible time of delivery of the requested part is determined. At this stage, plausibility will be checked for the first time. If the allocated resources, the requested time of delivery and other parameters do not match, the task needs to be replanned. Hereinafter, a clearance 62 for executing the task 58 is asked from the planner 50. After providing the clearance 62 the customer 46 will receive a notification electronically.

A transport worker is chosen due to his availability at the desired time. The transport worker will be informed about a new task 58 which has to be executed. This can be e.g. the delivery of a wing skin panel from one far away storing position on the factory area to the assembly line with a chosen transport vehicle. This new instruction about the task 58 is transmitted to the transport worker preferably via a wireless communication between the server 34, the wireless module 42 and the worker's wireless device 44. This is advantageous because there is no loss of information from the time the customer sends the request until the worker receives the instruction due to the direct and digital transmission without handwritten instruction papers and the such.

When reaching the proposed starting time of the task 58 the worker will start to follow the relevant instructions (indicated by 64). The transport worker informs the system, that the execution of the task has started physically.

In case of unforeseen events that interrupt 66 the transport, the transport worker is able to immediately inform the system or the transport planner 50, thus enabling the dynamic replanning 68 of all further tasks in queue. In case of those unforeseen events, like failure of a transport vehicle, the task will be returned to the status “request in planning” 56. The customer 46 will be informed 70 about the change in the time plan.

Also, the transport management module 12 checks whether all tasks are in execution as planned. In case that it is not possible to detect the execution of task 58, which can be caused by absence of the transport worker or other problems, the task 58 will be replanned 68 as well. A notification will be sent to the requesting customer 46 (indicated by 70).

After reaching the proposed task end time it will be determined 72 by the transport management module 12, whether the task 58 was executed properly. This can be realised by checking of a positive feedback of the transport worker, who used the wireless device 44 for this purpose. This ends up in either successful or unsuccessful completion 74 of the task 58, which is reported 76 to the customer 46.

If the task management module 12 determines by a check routine 78, that a task 58 was not executed or a request 48 was not considered, the request 48 is going to be reported once again to the planner 50 (indicated by 80) and the customer 46 (ind. by 82).

The above described system, method and computer programmes provide the ability to improve part transportation and controlling in a factory environment by optimisation of all available resources like transport workers, transport vehicles and time. The embodiments shown do not limit the scope of invention and are meant to clarify the idea according the present invention. Therefore, this invention is not limited to the use in an aircraft manufacturing industry, nor is it limited to the use within only one enclosed factory space. It is easily possible to use the system, the method and the computer programmes of the present invention to coordinate parts transportation between different factory areas, different cities and different countries under usage of all available transport vehicles, like aircraft, trains, ships, trucks etc.

1. A system for planning and controlling of objects transportation, the system comprising:
at least one server unit;
at least one client unit;
at least one communication device;
at least one database unit with objects and factory area data, the at least one database unit being adapted to interact with the at least one server unit;
wherein the at least one client unit is adapted to send requests for objects to the at least one server unit;
wherein the at least one server unit is adapted to receive and process the requests for objects; and
wherein the at least one server unit creates a request list considering at least informations about the object and the time of delivery of the object and automatically sends transport instructions to data transferring devices using the at least one communication device.

2. The system according to claim 1, wherein the data transferring devices are wireless data transferring devices.

3. The system according to claim 2, wherein the at least one communication device and the wireless data transferring devices communicate using DECT.

4. The system according to claim 2, wherein the at least one communication device and the wireless data transferring devices communicate using wireless Ethernet.

5. The system according to claim 1, wherein the wireless data transferring devices are adapted to send at least one of transport beginning messages, transport progress messages, transport interruption messages or transport completion messages to the at least one server unit.

6. The system according to claim 1, wherein the server unit is adapted to report at least one of transport beginning, transport progress, transport interruption or transport completion to a transport planner or a customer.

7. The system according to claim 1, wherein the at least one server unit is adapted to automatically check the plausibility of a transport plan.

8. The system according to claim 7, wherein the at least one server unit is adapted to automatically rebuild the transport plan in case of the plausibility is negative or the completion of a transport task is not possible in time.

9. A method for planning and controlling of objects transportation, said method comprising:
sending a request for transport of an object from at least one client unit to at least one server unit;
receiving and processing the request by the at least one server unit;
accepting the request by a transport planner;
creating a request list considering at least information about the object and time of delivery of the object; and
automatically sending transport instructions to data transferring devices using a communication device.

10. The method according to claim 9,
wherein transport tasks are created from the request list;
wherein the transport tasks are executed; and
wherein at least one of a start, progress, interruption or completion of the transport task are reported to the server unit using the data transferring devices.

11. The method according to claim 9, wherein the server unit reports at least one of a start, progress, interruption, or completion of the transport task to at least one of the transport planner or the customer.

12. The method according to claim 9, wherein the at least one server unit automatically checks the plausibility of the start transport plan.

13. A computer-readable medium having stored thereon instructions that, when executed, directs a computer to:
send a request for transport of an object from at least one client unit to at least one server unit;
receive and process the request by the at least server unit;
accept the request by a transport planner;
create a request list considering at least information about the object and time of delivery of the object; and
automatically send transport instructions to data transferring devices using a communication device.
